(19) United States
(12) Patent Application Publication
(10) Pub. No.: US 2010/0008070 A1
(43) Pub. Date: Jan. 14, 2010

(54) BACK LIGHT MODULE WITH DIFFRACTIVE COUPLERS

(76) Inventor: Wai Hon Lee, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/170,615

(22) Filed: Jul. 10, 2008

(51) Int. Cl. F21V 8/00

(52) U.S. Cl. 362/97.2; 362/97.1

(57) ABSTRACT

A back light module which uses first diffractive optics to couple light into a light guide and uses second diffractive optics to extract light from the light guide such that the light emerging from the back light module is uniform. This is accomplished by having an input grating adjacent the light sources at the bottom, or back of the light guide, with the output grating at the top, or front of the light guide. In one embodiment, the portion of the top surface directly opposite the light sources has a less dense arrangement of diffractive couplers, so that less of the initial light from the light sources exits upon the first contact with the top surface. Alternately, a modular light guide with angled light guide surfaces is used to couple in light from the light source, instead of the diffractive in-couplers.

### CROSS-REFERENCES TO RELATED APPLICATIONS

This application is related to co-pending application Ser. No. 12/035,276 entitled “Back Light Module With Micro Fresnel Lens” which was filed on Feb. 21, 2008, which is hereby incorporated herein in its entirety.

### BACKGROUND OF THE INVENTION

The present invention relates to light guides for Liquid Crystal Displays (LCDs), and in particular to the use of a diffraction grating to redirect light from a light source.

LCD displays are used in televisions, computer monitors, mobile phones and other devices. LCD displays use a back light module to illuminate the LCD display. There are two popular methods for the placement of the light source. For large screens the light source is placed behind the LCD display. For smaller screens the light source is placed on the side of a light guide. The most common light source used in television is CCFL (cold cathode fluorescent lamp), which requires a high voltage source. A more energy efficient light source is the Light Emitting Diode (LED). However, there are obstacles to using LEDs. Fluorescent light (CCFL) is typically used for large screen TVs, while smaller displays, such as mobile phones, can use LEDs.

There are many examples of improvements on this basic back light module. For example, U.S. Pat. No. 5,392,199 and No. 5,647,655 show a reflecting plate below a light guide, and a diffusion layer above it. The ends of the cylindrical reflector around the light source are bonded to the light guide. U.S. Pat. No. 5,779,337 shows a light guide with a plurality of projections or grooves arrayed on the light emitting (top) surface to cause more light to be emitted. U.S. Pat. No. 6,115,058 shows an LCD using polarizing filters and a Fresnel lens 201 bonded to the back of the LCD. U.S. Pat. No. 6,710,829 shows a press to generate a plurality of recesses of different sizes on the illuminating plate of a back light plate. U.S. Pat. No. 7,160,018 shows a back light plate with an array of prisms on the front or top, and reflective dots on the bottom surface. U.S. Pat. No. 7,270,466 shows a bottom reflecting surface with different sized and spaced protrusions on the two sides of the reflecting surface.

FIG. 1 shows a typical back light module used in LCD televisions which contains a light source 101 (e.g., CCFL tubes), a reflector 102, a volume diffuser 103 and additional thin diffusers 105, 106 and 107. The volume diffuser 103 contains micro particles 104 to scatter the light from the light source into many different angles. As a result, light emerging from the diffuser 103 becomes spatially uniform. The uniform appearance of the light from the back light module is dependent on the diverging cone of the light source 101, the distance between the light source and the diffuser 103 and the thickness of diffuser 103. In practice, it is not sufficient to use just diffuser 103. Additional thin diffusers 105, 106 and 107 have to be added to diffuse the light, so that the viewer doesn't see bright spots or line where the light sources are. The uniformity of prior art back light module is accomplished by scattering the light from the light source over wide angles. Hence, the prior art back light module has low light efficiency. The fact that multiple pieces of diffusers are needed increases the cost of the back light module.

Diffraction gratings have been used to spread the light in light guides to reduce the need for the number of diffusers shown in FIG. 1. U.S. Pat. No. 6,196,691 describes a single, ruled diffraction structure on the bottom of the light guide to couple light out. The diffractive structure has a constant period. U.S. Pat. No. 6,598,987, “Method and Apparatus for Distributing Light to the User Interface of an Electronic Device” (Nokia), filed Jun. 15, 2000. The Nokia '987 patent uses an input grating to couple the light into a light guide, with an output grating on the bottom surface of the light guide (around the input grating).

Other patents discussing diffraction gratings in light guides include U.S. Pat. No. 7,085,056 “Light guide plate with diffraction gratings and backlight,” U.S. Pat. No. 7,364,340; U.S. Pat. No. 7,242,838, which describes a light source on the side with a reflection layer formed on the base. The reflection layer defines a number of diffraction grating units. Grating constants of the diffraction grating units progressively decrease with increasing distance away from the light incidence surface. This enables the light emitting surface to output highly uniform light. See also published application No. 20070058394.

### BRIEF SUMMARY OF THE INVENTION

This present invention provides a back light module which uses first diffractive optics to couple light into a light guide and uses second diffractive optics to extract light from the light guide such that the light emerging from the back light module is uniform. This is accomplished by having an input grating adjacent the light sources at the bottom, or back of the light guide, with the output grating at the top, or front of the light guide. This enables the portions of the output grating to be directly over the light sources, unlike the prior art Nokia U.S. Pat. No. 6,598,987, which puts both the input and output gratings on the same bottom surface.

In one embodiment, input diffractive grating diffracts the entering light so that most of the light reflects off the top surface, and then off the bottom and other surfaces, spreading the light through the light guide before it exits. The top surface has micro diffractive couplers for pulling light out of the light guide. The portion of the top surface directly opposite the light sources has a less dense arrangement of diffractive couplers, so that less of the initial light from the light sources exits upon the first contact with the top surface. The arrangement of diffractive couplers is denser in areas farther away from the light source.

In an alternate embodiment, a modular light guide with angled light guide surfaces to couple in light from the light source is used, instead of the diffractive in-couplers. An array of the modules is formed, with a light source beneath a v-shape formed by the intersection of the modules, with the angled v surfaces coupling light into the light guide.

### BRIEF DESCRIPTION OF THE DRAWINGS

FIG. 1 is a diagram of a prior art back light module.

FIG. 2 is a diagram of a back light module with diffractive couplers according to an embodiment of the present invention.

FIG. 3 is a diagram of a modular back light module with light sources between modules according to an embodiment of the present invention.

### DETAILED DESCRIPTION OF THE INVENTION

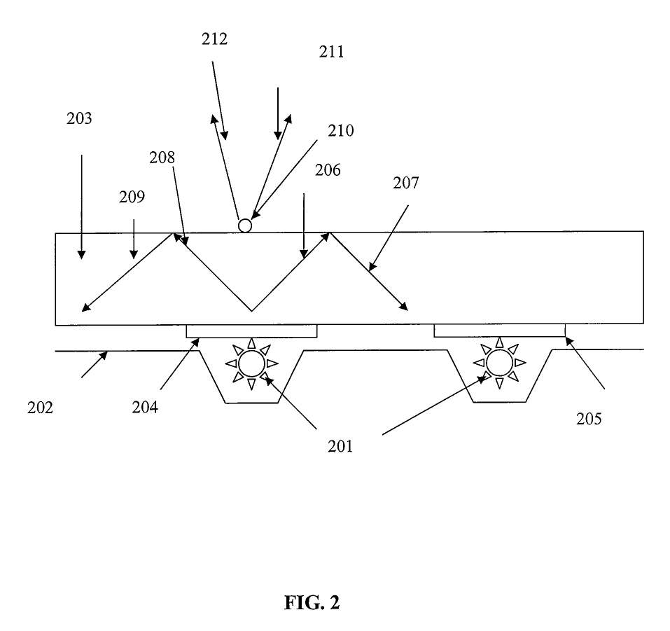

FIG. 2 is a diagram of a back light module according to an embodiment of the present invention. The back light module contains light sources 201, a reflector 202 and a light guide plate 203. There is a diffractive coupler 204 attached to the bottom of the light guide and in front of the light source. Without diffractive coupler 204, the light from light source 201 will pass through the light guide plate 203. With the diffractive couplers 204, the incident light on the coupler will be diffracted by an angle larger than the critical angle of the light guide. Hence light beams 206 and 208 will be reflected by the top surface of light guide 203 and propagate away from the location of the light source. On the top surface of the light guide there are micro diffractive couplers 210 to extract light 211 and 212 from the light guide. The micro couplers are less dense in area close to the light source and become denser in areas away from the light source. By coupling the light from the light source and propagating the light away from the light source, a uniform back light module can be made with few components and which is more compact.

In one embodiment, the light sources 201 are fluorescent (CCFL) tubes. Alternate embodiments use LEDs. The diffractive couplers are elongated, matching the tubes. The diffractive couplers are designed to diffract the light at an angle greater than the total internal reflections. In addition, the placement of the light source relative to the grating and the length of the diffractive couplers is also optimized. The diffractive couplers, in one embodiment, are an array of micro grooves. Although shown as a separate element attached to the light guide, the diffractive couplers can be laminated to the light guide or can be directly embossed on the light guide surface.

The out couplers 210 are micro arrays, with spacing between them. The arrays are not very dense above the light source, where the 0 angle (undiffracted) light will hit the top surface first. Only enough light is coupled out to match the amount of light that will be coupled out in between the light sources, to give uniform illumination. Because of the variations in materials and light sources, the variations in the pattern of the micro arrays is typically determined through a process of trial and error.

The overall pattern of the input and output diffractive coupler arrays can be generated on a thin film by electron beam lithography or other means. This can be used as a master to impress the pattern on the light guide as the light guide is molded or pressed. This will allow the light guide to be manufactured with integral in-coupling and out-coupling diffractive gratings. This allows for a thinner light guide structure.

In one embodiment, a diffuser layer is used. The diffraction gratings will cause some separation of the light by wavelength, which may affect the desired white color. To maintain the white color, a diffusion layer is added over the diffraction layer.

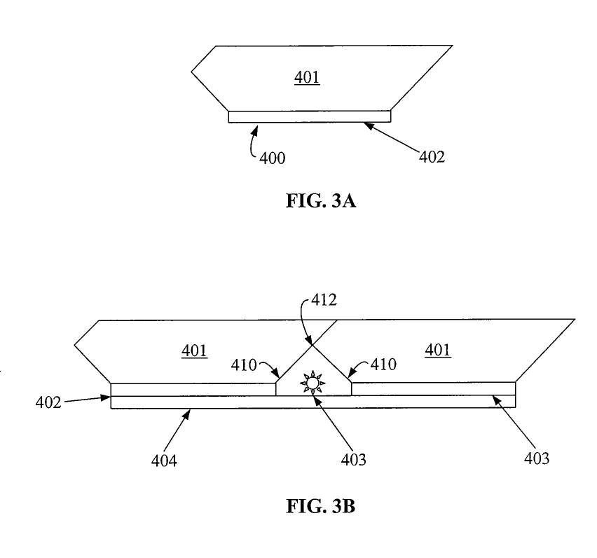

FIGS. 3A and 3B show another embodiment of the invention using a modular light guide with angled light guide surfaces to couple in light from the light source, instead of the diffractive in-couplers of FIG. 2. FIG. 3A shows a single module, with the connection of two modules being shown in FIG. 3B. The module or unit 400 of FIG. 3A has a clear plastic structure 401 for the light guide, with a hologram 402 either laminated or embossed directly on light guide structure 401 to redirect to a normal direction to exit the light guide. The surface of the hologram not in contact with 401 (the outer surface) is metallized to form the diffraction pattern. The diffraction pattern will diffract light to the top of structure 401 where it will exit the light guide.

Two units of structure 400 are connected as shown in FIG. 4B. A light source 403 is placed under the v structure created where the two structures 401 meet as shown. A bottom reflector 404 is placed behind the light source 403. The light source 403 can be CCFL or LED. In this embodiment the light is coupled into the light guide through the prismatic surface of the edges 410 of units 401, which are at an angle, such as 45 degrees. A further description of the benefits and effects of the angled edge are set forth in above referenced related co-pending application Ser. No. 12/035,276 entitled “Back Light Module With Micro Fresnel Lens” which was filed on Feb. 21, 2008, which is incorporated herein by reference. The holograms 402 decouple the light from the light guide to produce a uniform illumination.

An apex 412 is formed below the top surface of the light guide by the overlapping of the angled top edge of left unit 401 over right unit 401. This prevents light from the light source directly exiting the light guide above the light source, preventing a bright spot. No significant light will go through the apex, instead being directed left or right by the angled edges.

A large back light module can be fabricated by cascading more of the basic module 400. In one embodiment, a series of parallel modules 401 are used, each 2-3 inches wide, with a light source between each one, and optionally light sources at the outer edge of the last modules. Since the modules are relatively narrow, a constant diffraction pattern can be used. Alternately, the pattern can vary, such as by diffraction out less light near the edges, and more near the center. An example of such variation is described in the above-referenced co-pending application. The modules can be assembled by gluing them together, using a press fit with notch patterns, heating the modules to cause the plastic to partially melt together at the joints, or by any other process.

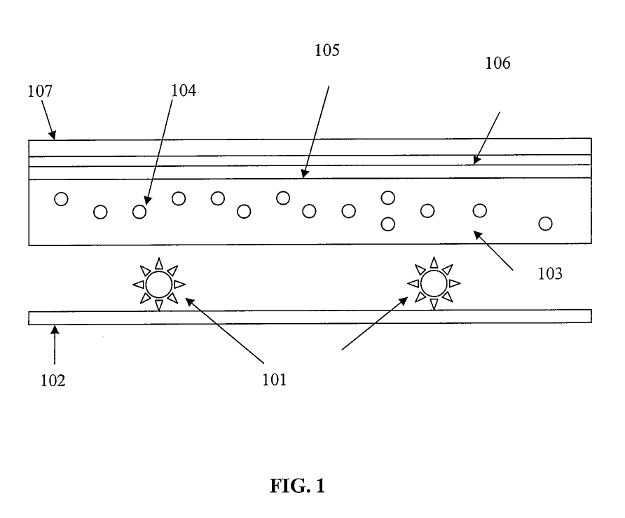

In one embodiment, a diffuser layer is placed over each unit 410 to diffuse the separation of colors caused by the diffraction patterns, as discussed above. Such a diffuser layer can be similar to one of the layers shown in FIG. 1. In an alternate embodiment, the hologram can be placed on the top, exit surface, or holograms on both the top and bottom surfaces can be used.

It is to be understood that the examples and embodiments described above are for illustrative purposes only and that various modifications or changes in light thereof will be suggested to persons skilled in the art and are to be included within the spirit and purview of this application and scope of the appended claims. For example, an array of LEDs could be used instead of CCFL tubes. LEDs of different colors are arranged to produce a combined white light, with the diffractive patterns being optimized for the wavelengths of each color. Alternately, instead of parallel modules, a two-dimensional grid could be used. Therefore, the above description should not be understood as limiting the scope of the invention as defined by the claims.

What is claimed is:

1. A light guide apparatus for a display, comprising:
a light guide;
an array of light sources mounted below said light guide;
a reflector plate mounted below said light sources;
a plurality of in-couplers mounted on said light guide adjacent said plurality of light sources; and
a plurality of diffractive out-couplers mounted on top surface of said light guide.

2. The apparatus of claim 1, wherein the light sources are cold cathode fluorescent lamps (CCFL).

3. The apparatus of claim 1, wherein the light sources are light emitting diodes (LED).

4. The apparatus of claim 1 wherein the in-couplers are angled surfaces of said light guide.

5. The apparatus of claim 4 wherein said angled surfaces are the edges of a plurality of modular light guide units, said units being joined together to form said light guide.

6. The apparatus of claim 1 wherein the in-couplers are diffractive structures mounted on a bottom surface of said light guide.

7. The apparatus of claim 1 wherein said diffractive out-couplers comprise an array of micro diffractive out-couplers, with a density of said array being less on portions of a top surface of said light guide opposite said light sources.

8. The apparatus of claim 7 wherein the density of said array varies as a function of a distance from one of said light sources.

9. The apparatus of claim 1 wherein said diffractive out-couplers are embossed on a surface of said light guide.

10. The apparatus of claim 1 wherein said diffractive out-couplers are laminated to a surface of said light guide.

11. The apparatus of claim 1 wherein said display is an LCD display.

12. A light guide apparatus for an LCD display, comprising:
a light guide;
an array of light sources mounted below said light guide;
a reflector plate mounted below said light sources;
a plurality of diffractive in-couplers mounted on a bottom surface of said light guide adjacent said plurality of light sources; and
a plurality of diffractive out-couplers mounted on top surface of said light guide, wherein said diffractive out-couplers comprise an array of micro diffractive out-couplers, with a density of said array being less on portions of a top surface of said light guide opposite said light sources.

13. A light guide apparatus for an LCD display, comprising:
a light guide formed from a plurality of light guide modules, each module having an angled surface which mates with an adjoining module;
an array of light sources mounted below said light guide, each of said light sources being mounted in a gap caused by said angled surfaces between adjacent light guide modules;
a reflector plate mounted below said light sources; and
a plurality of diffractive out-couplers mounted on a surface of said light guide.

14. The apparatus of claim 13 wherein said diffractive out-couplers comprise an array of micro diffractive out-couplers.
